(19) United States
(12) Patent Application Publication
(10) Pub. No.: US 2026/0326682 A1
(43) Pub. Date: Oct. 22, 2026

(54) BRACKET FOR MODULE OF VEHICLE

(71) Applicant: Ford Global Technologies, LLC, Dearborn, MI (US)

(72) Inventors: William Richard Navas, III, Livonia, MI (US); Sai Kalyan Pulipati, Canton, MI (US); Russell Knight, Holly, MI (US); Rezaul Choudhury, Sterling Heights, MI (US)

(73) Assignee: Ford Global Technologies, LLC, Dearborn, MI (US)

(21) Appl. No.: 19/184,285

(22) Filed: Apr. 21, 2025

(51) Int. Cl. B60R 11/02; B60R 11/00

(52) U.S. Cl. CPC B60R 11/0264; B60R 2011/0052; B60R 2011/0066; B60R 2011/008

(57) ABSTRACT

A bracket for a module of a vehicle includes a body and a pair of opposed guide rails. The body is configured to be coupled to the vehicle. The pair of opposed guide rails extend from the body. Each guide rail of the pair of opposed guide rails defines a channel configured to receive a respective mounting feature of the module. Each guide rail of the pair of opposed guide rails further includes a cutout in communication with the channel at a location of the guide rail and configured to receive the respective mounting feature from the channel.

### FIELD

The present disclosure relates to a bracket for a module of a vehicle.

### BACKGROUND

The statements in this section merely provide background information related to the present disclosure and may not constitute prior art.

Vehicles includes a plurality of vehicle modules that may control parts of the vehicle. For example, the vehicle may include an engine control module that controls multiple systems of an internal combustion engine. In another example, the vehicle may include a suspension module that controls the suspension and adjust the tension for each wheel. The vehicle modules may be coupled to the vehicle at locations where there is not a lot of space due to fenders, brackets, body panels, and other vehicle parts being located in the area. This presents a challenge for coupling the vehicle modules to the vehicle.

These issues related to coupling vehicle modules to the vehicle, among other issues related to coupling vehicle modules to the vehicle, are addressed by the present disclosure.

### SUMMARY

This section provides a general summary of the disclosure and is not a comprehensive disclosure of its full scope or all of its features.

In one form, the present disclosure provides a bracket for a module of a vehicle. The bracket includes a body and a pair of opposed guide rails. The body is configured to be coupled to the vehicle. The pair of opposed guide rails extend from the body. Each guide rail of the pair of opposed guide rails defines a channel configured to receive a respective mounting feature of the module. Each guide rail of the pair of opposed guide rails further comprises a first cutout in communication with the channel at a first location of the guide rail and configured to receive the respective mounting feature from the channel.

In variations of the bracket of the above paragraph, which can be implemented individually or in any combination: a pair of rail surfaces are configured to support the module, each rail surface of the pair of rail surfaces extending between the body and a respective guide rail of the pair of opposed guide rails; the first cutout includes a first portion in communication with the channel and a second portion in communication with the first portion, the second portion is located closer towards the rail surface then the first portion; the first cutout includes a first portion in communication with the channel and a second portion in communication with the first portion, the second portion is located closer towards an end of the guide rail then the first portion; each guide rail of the pair of opposed guide rails further includes a second cutout in communication with the channel at a second location of the guide rail and configured to receive the respective mounting feature from the channel, the second cutout is spaced apart from the first location; a shape of the first cutout is different from a shape of the second cutout; each guide rail of the pair of opposed guide rails includes a flat portion and an arcuate portion, the arcuate portion defines the channel; the first cutout is formed in the flat portion and the arcuate portion; a plurality of mounting features configured to couple the bracket to the module, at least one mounting feature of the plurality of mounting features extends from an upper end of the body and at least one mounting feature of the plurality of mounting features extends from a lower end of the body; and a stop member extends from the upper end of the body above the pair of opposed guide rails.

In another form, the present disclosure provides a bracket for a module of a vehicle that includes a body and a pair of opposed guide rails. The body is configured to be coupled to the vehicle. The pair of opposed guide rails extend from the body. Each guide rail of the pair of opposed guide rails includes a first part, a second part, a first cutout and a second cutout. The second part has a different shape then the first part and defines a channel configured to receive a respective mounting feature of the module. The first cutout is formed in the guide rail of the pair of opposed guide rails. The first cutout is in communication with the channel at a first location of the guide rail and is configured to receive the respective mounting feature from the channel. The second cutout is formed in the guide rail of the pair of opposed guide rails. The second cutout is in communication with the channel at a second location of the guide rail and is configured to receive the respective mounting feature from the channel.

In variations of the bracket of the above paragraph, which can be implemented individually or in any combination: the first part is flat, and the second part is arcuate; the first cutout is formed in flat first part and the arcuate second part of the guide rail, the second cutout is formed in the flat first part and the arcuate second part of the guide rail; a pair of rail surfaces configured to support the module, each rail surface of the pair of rail surfaces extends between the body and a respective guide rail of the pair of opposed guide rails; and each of the first cutout and the second cutout includes a first portion in communication with the channel and a second portion in communication with the first portion, the second portion is located closer towards the rail surface then the first portion.

In yet another form, the present disclosure provides a method that includes inserting a vehicle module into a bracket such that mounting features of the vehicle module are received in channels of a pair of opposed guide rails of the bracket, moving the vehicle module into a first position in which the mounting features are moved from the channels to first cutouts in the pair of opposed guide rails, and coupling a first set of electrical components to corresponding first terminals of the vehicle module while the vehicle module is in the first position.

In variations of the method of the above paragraph, which can be implemented individually or in any combination: the method further includes moving the vehicle module from the first position after the first set of electrical components are coupled to the corresponding first terminals; moving the vehicle module into a second position in which the mounting features are moved from the channels to second cutouts in the pair of opposed guide rails; coupling a second set of electrical components to corresponding second terminals of the vehicle module while the vehicle module is in the second position; securing the vehicle module and the bracket to each other after the first set of electrical components are coupled to the corresponding first terminals and the second set of electrical components are coupled to the corresponding second terminals; and the vehicle module moves in a substantially vertical direction from the first position to the second position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a brackets according to the principles of the present disclosure;

FIG. 2 is a perspective view of a portion of the vehicle of FIG. 1 including the brackets;

FIG. 3 is a perspective view of the bracket of FIG. 2;

FIG. 4 is a side view of the bracket of FIG. 2;

FIG. 5 is an end view of the bracket of FIG. 2;

FIGS. 6A-6F are views of a vehicle module being moved to a first position in which mounting features of the vehicle module are received in a first pair of cutouts of the bracket;

FIG. 7 is a perspective view of a first set of electrical components being electrically connected to the vehicle module when the vehicle module is in the first position;

FIGS. 8A-8G are views of a vehicle module being moved to a second position in which the mounting features of the vehicle module are received in a second pair of cutouts of the bracket;

FIG. 9 is a perspective view of a second set of electrical components being electrically connected to the vehicle module when the vehicle module is in the second position; and

FIG. 10 is a flowchart illustrating a method for assembling the vehicle module to the vehicle using the bracket of FIG. 2 according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

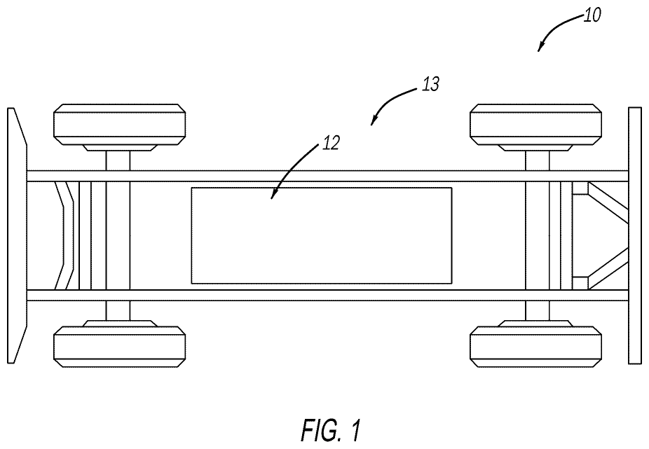

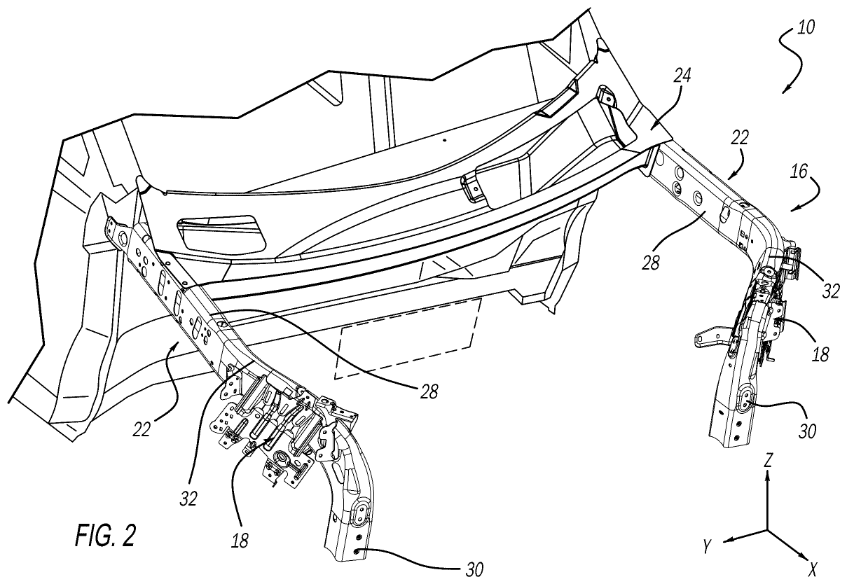

With reference to FIGS. 1 and 2, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. In still other examples, the vehicle may be an internal combustion engine driven vehicle. In the example provided, the vehicle 10 is a body-on-frame type of vehicle, though other types of vehicle architecture can be used, such as uni-body for example.

In the example provided, the vehicle 10 includes a battery pack 12 (FIG. 1), a vehicle frame 13 (FIG. 1), a front-end structural assembly 16 (FIG. 2), and one or more brackets 18 (FIG. 2). The battery pack 12 may be disposed at various locations of the vehicle 10 and may be mounted to the vehicle frame 13. In this way, the battery pack 12 is supported by the vehicle frame 13 and is remote from a passenger cabin (not shown) and cargo compartments (not shown) of the vehicle 10, therefore, not occupying space that would otherwise be available for passengers or cargo. The battery pack 12 powers a rear motor (not shown) to drive a set of rear wheels (not shown) and/or powers a front motor (not shown) to drive a set of front wheels (not shown).

The front-end structural assembly 16 is a supporting structure of vehicle components and panels and includes, inter alia, a pair of opposed upper tubes or rails 22 and a cross bar (not shown). A cowl panel 24 spans a width of the vehicle 10 (i.e., extends in a transverse direction relative to a longitudinal direction of the vehicle 10) and is secured to the upper tubes 22 of the front-end structural assembly 16. The cowl panel 24 partially supports a vehicle windshield (not shown) and dashboard (not shown). The cowl panel 24 also covers the space between the vehicle hood panel (not shown) and the vehicle windshield (not shown), thereby protecting unwanted debris and fluids from entering into vehicle systems such as the windshield wiper system, for example.

The upper tubes 22 extend from an upper portion of a respective front pillar (not shown) to the cross beam (not shown). The upper tubes 22 are located above a respective front wheel well and extend along the longitudinal direction of the vehicle 10. With reference to FIG. 2, each upper tube 22 includes a longitudinal portion 28, a riser portion 30, and a transition portion 32. The longitudinal portion 28 extends along the longitudinal direction of the vehicle 10. The riser portion 30 is located at a front end of the vehicle 10 and acts as a mounting location for the cross beam. Stated differently, the riser portion 30 is located further forward of the vehicle 10 relative to the longitudinal portion 28 and the transition portion 32. The riser portion 30 extends in a vertical direction of the vehicle 10 and has a lower end that is located below the longitudinal portion 28 and the transition portion 32 of the upper tube 22. The transition portion 32 extends inwardly from the longitudinal portion 28 to the riser portion 30 and may also extend at an angle inwardly and downward to the riser portion 30. Stated differently, the riser portions 30 of the upper tubes 22 are closer toward each other than the longitudinal portion 28 of the upper tubes 22.

With continued reference to FIG. 2, each bracket 18 is secured to corresponding tubes 22 of the vehicle 10 and is configured to couple a respective vehicle module 34 to the tube 22. The bracket 18 provides the benefit of supporting the vehicle module 34 while allowing electrical components (e.g., wire harnesses) to be electrically connected to the vehicle module 34 particularly in tight spaces. For example, the vehicle modules 34 may be coupled to the vehicle 10 at locations where there is not a lot of space due to fenders, brackets, body panels, and other vehicle parts being located in the area. The bracket 18 of the present disclosure facilitates coupling of the vehicle module 34 to the vehicle 10 and also facilitating electrical coupling of the electrical components 21 to vehicle module 34.

In the example illustrated, the bracket 18 is coupled to the transition portion 32 of the tube 22. In some forms, the bracket 18 may be coupled to the longitudinal portion 28 and/or the riser portion 30 of the tube 22. Yet, in other forms, the bracket 18 may be coupled to the vehicle frame 13 or other parts of the vehicle 10 where there is not a lot of space due to vehicle parts being located in the space.

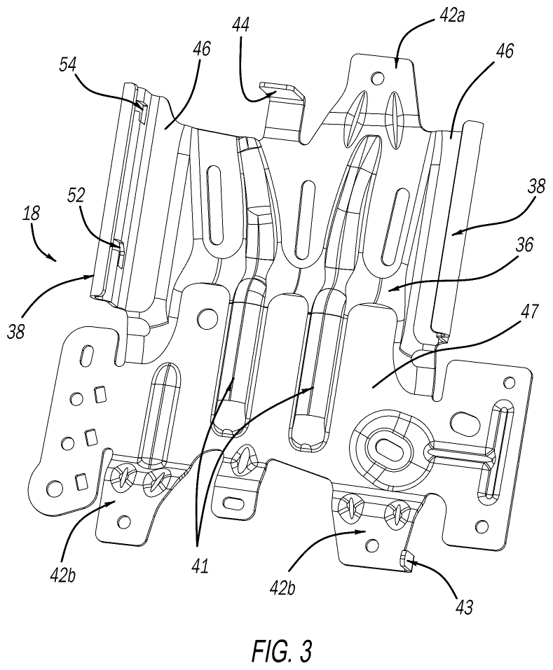

With reference to FIGS. 3-5, each bracket 18 extends in a substantially vertical direction (relative to the vehicle 10) and includes a body 36 and a pair of opposed guide rails 38. In the example illustrated, the body 36 is coupled to the transition portion 32 of the tube 22 using mechanical coupling (e.g., welding or fasteners such as bolts, screws, rivets, etc.). In some forms, the body 36 may be coupled to the longitudinal portion 28 and/or the riser portion 30 of the tube 22. In the example illustrated, the body 36 is a plate structure including a plurality of openings (FIG. 3) and/or slots (FIG. 3) formed therein that facilitate attachment to the tube 22. The body 36 also includes stamped ridges 41, which adds strength to the bracket 18. A portion of the body 36 between the pair of opposed guide rails 38 is recessed at an angle towards to tube 22 to facilitate engagement of the bracket 18 to the tube 22. Stated differently, the portion of the body 36 between the pair of opposed guide rails 38 has a depression to facilitate engagement of the bracket 18 to the tube 22.

With reference to FIG. 3, a plurality of mounting features 42a, 42b extend from the body 36 and couple the bracket 18 to the vehicle module 34 as will be described in more detail below. At least one mounting feature 42a extends from an upper end of the body 36 above the pair of opposed guide rails 38 and at least one mounting feature 42b extends from a lower end of the body 36 below the pair of opposed guide rails 38. An alignment feature 43 may extend outward (i.e., away from the tube 22) from one of the mounting features 42b and may facilitate alignment of the vehicle control module 34 with the pair of opposed guide rails 38 as the vehicle control module 34 is being inserted vertically into the pair of opposed guide rails 38. A stop member 44 extends from the upper end of the body 36 above the pair of opposed guide rails 38 and limits upward movement of the vehicle control module 34 beyond the location of the stop member 44.

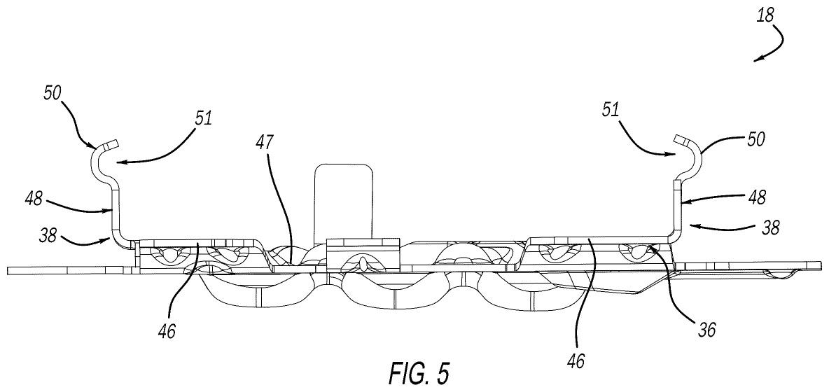

With reference to FIGS. 3 and 5, a pair of rail surfaces 46 extend between respective sides of the body 36 and respective guide rails 38 of the pair of opposed guide rails 38, and are configured to support the vehicle module 34 as electrical components 21 are being connected thereto. In this way, the vehicle module 34 is inhibited from moving in a traverse direction relative to the longitudinal direction of the vehicle 10. In the example illustrated, the pair of rail surfaces 46 are spaced apart from each other and are spaced apart from a surface 47 of the body 36 (extend further outward away from the tube 22 relative to the surface 47 of the body 36).

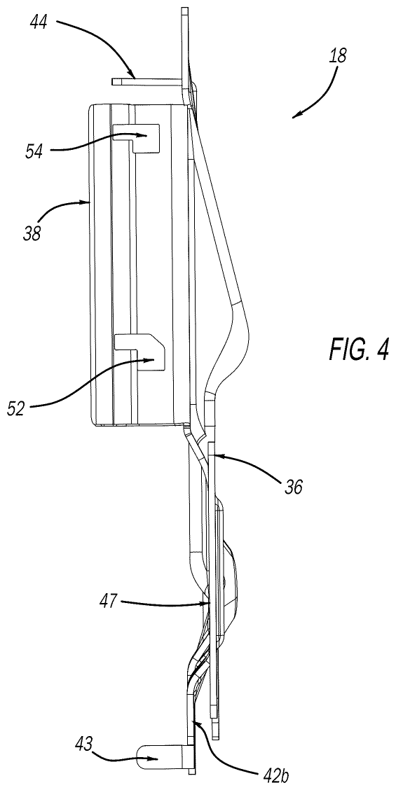

The pair of opposed guide rails 38 extend from the pair of rail surfaces 46. Each guide rail 38 includes a first part or portion 48, a second part or portion 50, a first cutout 52 (FIGS. 3 and 4) and a second cutout 54 (FIGS. 3 and 4). The first portion 48 extends perpendicular from a respective rail surface 46 and has a planar shape. The second portion 50 extends from the first portion 48 and defines a channel 51 extending through the guide rail 38. In the example illustrated, the second portion 50 has an arcuate shape or U-shape that defines the channel 51. In some forms, the second portion 50 may include a square shape or any other shape that defines the channel 51. It should be understood that the first portion 48 is located closer towards the rail surface 46 then the second portion 50. The channel 51 extends along an entire length of the guide rail 38 and is configured to receive a respective mounting feature 34a of the vehicle module 34 as will be described in more detail below.

With reference to FIGS. 3 and 4, the first cutout 52 is formed in the guide rail 38 and is in communication with the channel 51 at a first location of the guide rail 38. The first cutout 52 is configured to receive the respective mounting feature 34a of the vehicle module 34. In the example illustrated, the first cutout 52 has a generally L-shape and is formed in the first portion 48 and the second portion 50 of the guide rail 38. The first cutout 52 includes a first portion 52a and a second portion 52b. The first portion 52a of the first cutout 52 is in communication with the channel 51 and is formed in the second portion 50 of the guide rail 38. The second portion 52b is in communication with the first portion 52a and is located closer towards the rail surface 46 then the first portion 52a (i.e., located further inward towards the body 36 then the first portion 52a). The second portion 52b of the first cutout 52 is closer towards the lower end of the body then the first portion 52a and is defined by a lower surface 56a, opposing side surfaces 56b, and an upper chamfered surface 56c.

The vehicle module 34 may abut against or may be supported by the pair of rail surfaces 46 when the respective mounting feature 34a is received in the second portion 52b of the first cutout 52. When the respective mounting feature 34a is received in the second portion 52b of the first cutout 52, the respective mounting feature 34a is supported on the lower surface 56a to inhibit downward movement of the vehicle module 34. The lower surface 56a aligns the mounting features 34c, 42a of the vehicle module 34 and bracket 18, respectively. The lower surface 56a of cutout 54 also provides hand free coupling of the module 34 to the bracket 18 (i.e., inhibits module 34 from sliding opposite of loading direction) while operator grabs tools (not shown) to secure module 34 to the bracket 18. The opposing side surfaces 56b of the second portion 52b of the first cutout 52 further inhibits movement of the vehicle module 34 in the transverse direction (i.e., direction perpendicular to the longitudinal direction of the vehicle 10) when the respective mounting feature 34a is received in the second portion 52b of the first cutout 52. Due to the vertical orientation, the side surfaces 56b inhibit the vehicle module 34 from rotation or from engaging guide rails 38 once fully received in second portion 52b of the first cutout 52. The upper chamfered surface 56c of the second portion 52b facilities guiding of the mounting feature 34a between the channel 51 and the second portion 52b of the first cutout 52.

With continued reference to FIGS. 3 and 4, the second cutout 54 is formed in the guide rail 38 and is in communication with the channel 51 at a second location of the guide rail 38. That is, the first cutout 52 is in communication with the channel 51 at a location closer towards the lower end of the body 36 and the second cutout 54 may be in communication with the channel 51 at a location closer towards the upper end of the body 36. In the example illustrated, the second cutout 54 has a different outline or patten than the first cutout 52. In some forms, the second cutout 54 and the first cutout 52 may have the same outline or pattern.

The second cutout 54 is configured to receive the respective mounting feature 34a of the vehicle module 34. In the example illustrated, the second cutout 54 has a generally L-shape and is formed in the first portion 48 and the second portion 50 of the guide rail 38. The second cutout 54 includes a first portion 54a and a second portion 54b. The first portion 54a of the second cutout 54 is in communication with the channel 51 and is formed in the second portion 50 of the guide rail 38. The second portion 54b is in communication with the first portion 54a and is located closer towards the rail surface 46 then the first portion 54a (i.e., located further inward towards the body 36 then the first portion 54a). The second portion 54b of the second cutout 54 is closer towards the lower end of the body 36 then the first portion 54a and is defined by a lower surface 58a, opposing side surfaces 58b, and an upper surface 58c.

The vehicle module 34 may abut against or may be supported by the pair of rail surfaces 46 when the respective mounting feature 34a is received in the second portion 54b of the second cutout 54. When the respective mounting feature 34a is received in the second portion 54b of the second cutout 54, the respective mounting feature 34a is supported on the lower surface 58a to inhibit downward movement of the vehicle module 34. The opposing side surfaces 58b of the second portion 54b of the second cutout 54 inhibit movement of the vehicle module 34 in the transverse direction (i.e., direction perpendicular to the longitudinal direction of the vehicle 10) when the respective mounting feature 34a is received in the second portion 54b of the second cutout 54. Due to the vertical orientation, the side surfaces 58b inhibit the vehicle module 34 from rotation or from engaging guide rails 38 once fully received in second portion 54b of the second cutout 54.

Each vehicle module 34 is coupled to a corresponding bracket 18. In one example, the vehicle module 34 may be an engine control module that controls multiple systems of an internal combustion engine. In another example, the vehicle module 34 may be a suspension module that controls the suspension and adjust the tension for each wheel independently.

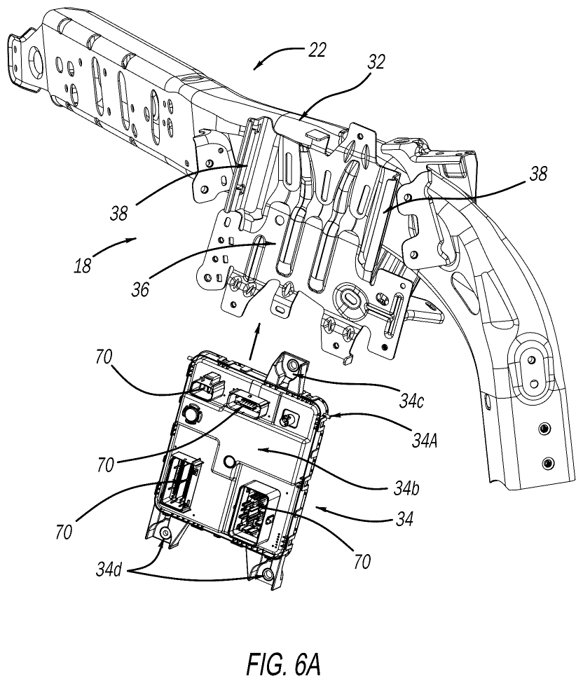

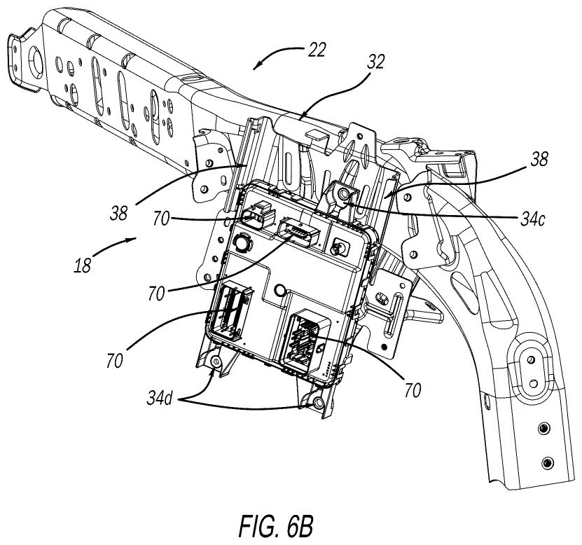

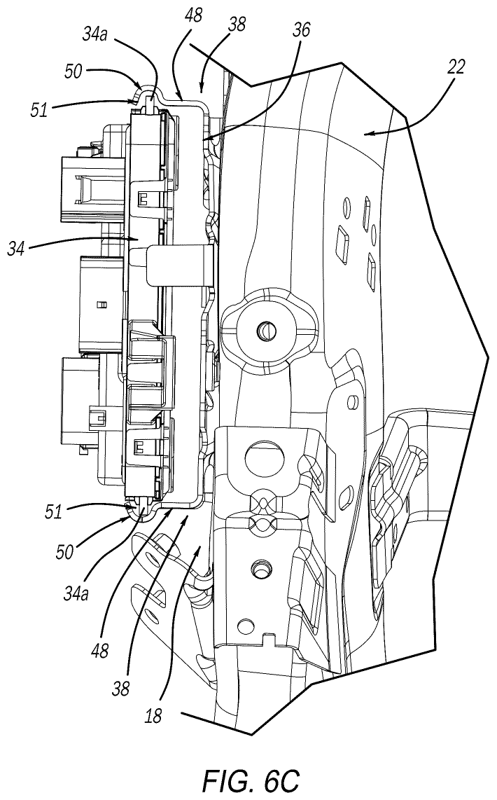

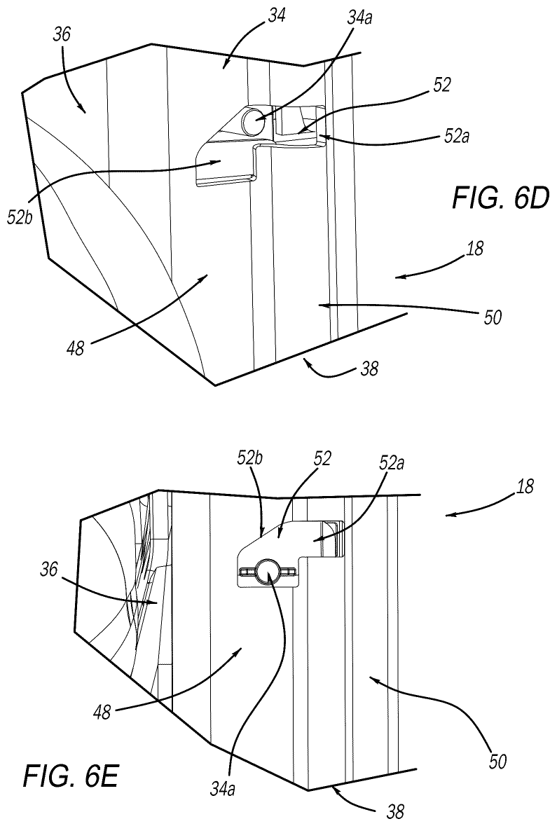

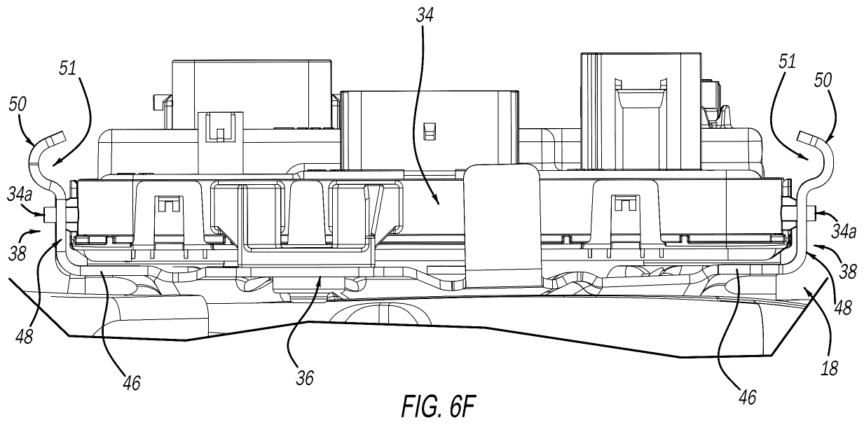

With reference to FIG. 6A, the vehicle module 34 includes a body 34b, the pair of opposed mounting features 34a (only one shown in the figure), and a plurality of mounting features 34c, 34d. The body 34a includes a plurality of terminals 70 configured to mate with electrical components 21 as will be described in more detail below. The pair of opposed mounting features 34a extend from the first and second sides of the vehicle module 34 and are configured to be received in the pair of opposed guide rails 38 as will be described in more detail below. In the example illustrated, the mounting features 34a have a cylindrical shape. In some forms, the mounting features 34a may include a square shape or any other suitable shape. The plurality of mounting features 34c, 34d extend from the body 34b and couple the vehicle module 34 to the bracket 18 as will be described in more detail below. At least one mounting feature 34c extends from an upper end of the body 34b and at least one mounting feature 34d extends from a lower end of the body 34b.

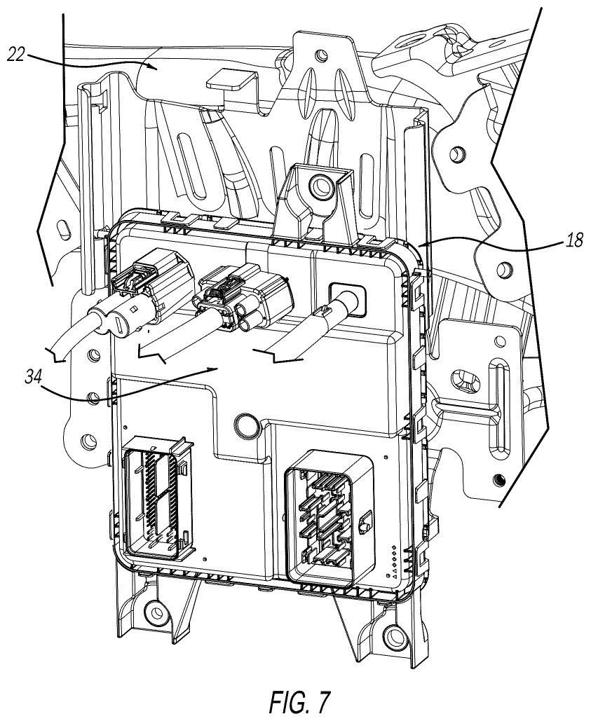

With reference to FIGS. 6A-6F, 7, 8A-8G and 9, a method for assembling the vehicle control module 34 to the vehicle 10 using the bracket 18 will be described in detail. At 204, the bracket 18 is coupled to the vehicle 10. In the example illustrated, the bracket 18 is coupled to the tube 22 of the vehicle 10. At 208, the vehicle module 34 is vertically inserted into the bracket 18 such that the mounting features 34a of the vehicle module 34 are received in the channels 51 of the pair of opposed guide rails 38 of the bracket 18 (FIGS. 6A-6C). In the channels 51, the vehicle module 34 is inhibited from moving in the longitudinal and transverse directions of the vehicle 10. At 212, the vehicle module 34 is moved into a first position in which the mounting features 34a of the vehicle module 34 are moved from the channels 51 into the second portions 52b of the first cutouts 52 of the pair of opposed guide rails 38 (FIGS. 6D-6F). At 216, In the first position, a first set of electrical components 21 may be electrically coupled to a first set of terminals 70 of the vehicle module 34 (FIG. 7). The vehicle module 34 may abut against the pair of rail surfaces 46 and the mounting features 42b when the vehicle module 34 is in the first position to inhibit rotation of the vehicle module 34 as well as further inhibit movement of the vehicle module 34 in the transverse direction. This, in turn, facilitates coupling of the first set of electrical components 21 to the first set of terminals 70.

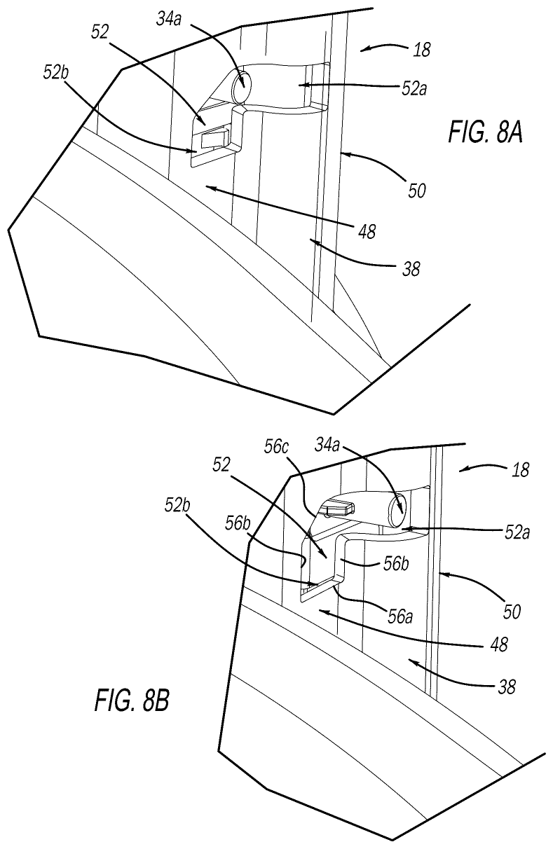

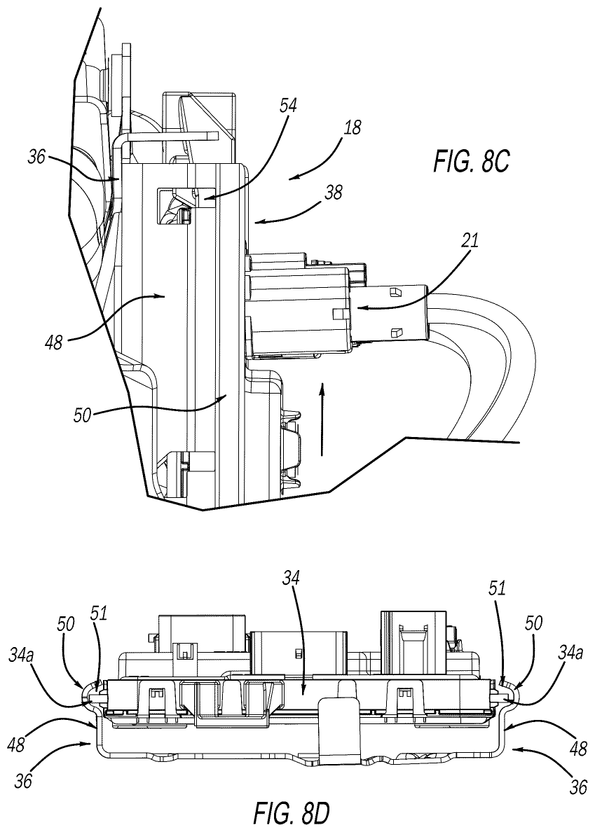

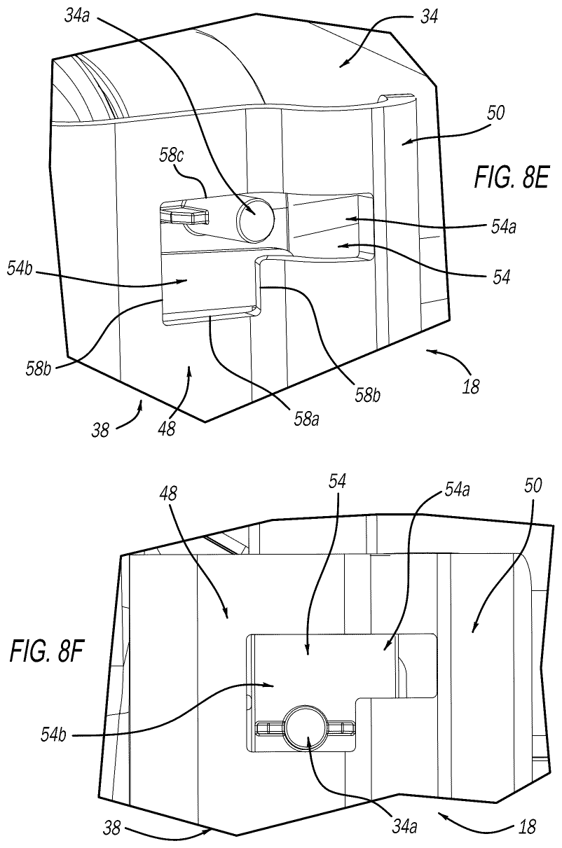

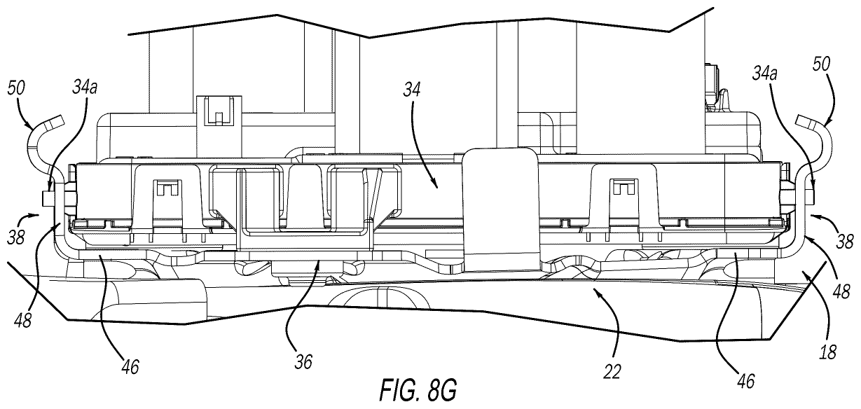

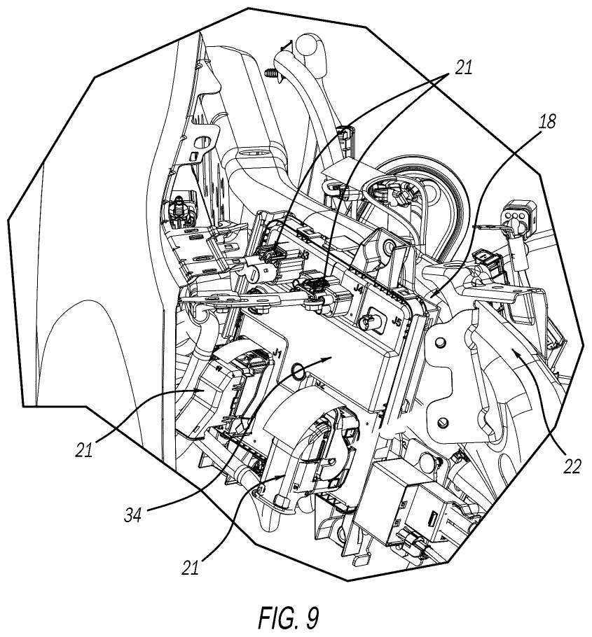

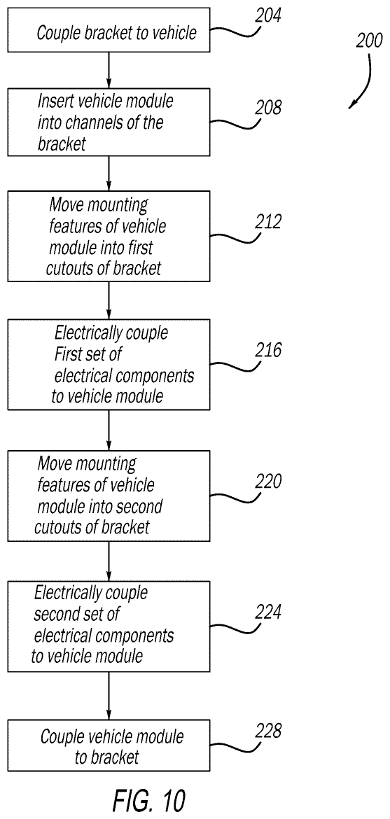

At 220, the vehicle module 34 is moved into a second position in which the mounting features 34 are moved from the channels 51 into the second portions 54b of the second cutouts 54 of the pair of opposed guide rails 38 (FIGS. 8A-8G). That is, after the first set of electrical components 21 are coupled to the first set of terminals 70 (lower terminals), the vehicle module 34 is moved from the first position into the channels 52. The vehicle module is moved in a substantially vertical direction from the first position to the second position. At 224, in the second position, a second set of electrical components 21 may be electrically coupled to a second set of terminals 70 of the vehicle module 34 (FIG. 9). It should be understood that the vehicle module 34 is inhibited from moving in the transverse direction until it reaches the first and second cutouts 52, 54. The vehicle module 34 may abut against the pair of rail surfaces 46 when the vehicle module 34 is in the second position to inhibit rotation of the vehicle module 34 as well as further inhibit movement of the vehicle module 34 in the transverse direction. This, in turn, facilitates coupling of the second set of electrical components 21 to the second set of terminals 70. The cutout 54 also provides hand free coupling and positioning of the module 34 relative to the bracket 18 (i.e., inhibits module 34 from sliding opposite of loading direction) while operator grabs tools and parts (not shown) to secure module 34 to the bracket 18. The lower surface 56a aligns the mounting features 34c, 42a of the vehicle module 34 and bracket 18, respectively, while allowing line of sight access to mounting features 34c, 42a to secure bracket 18 and module 34 around brackets, parts and other obstructions.

At 228, the vehicle module 34 is secured to the bracket 18 after the first set of electrical components 21 are coupled to the first set of terminals 70 and the second set of electrical components 21 are coupled to the second set of terminals 70. That is, mechanical fasteners (e.g., bolts, screws, rivets) extend through the mounting features 34c, 42a of the vehicle module 34 and bracket 18, respectively. Similarly, mechanical fasteners (e.g., bolts, screws, rivets) extend through the mounting features 34d, 42b of the vehicle module 34 and bracket 18, respectively.

The bracket 18 of the present disclosure provides the benefit of supporting the vehicle module 34 while allowing electrical components (e.g., wire harnesses) to be electrically connected to the vehicle module 34 particularly in tight spaces. For example, the vehicle module 34 may be coupled to the vehicle 10 at locations where there is not a lot of space due to fenders, brackets, body panels, and other vehicle parts being located in the area. The bracket 18 of the present disclosure facilitates coupling of the vehicle module 34 to the vehicle 10 and also facilitating electrical coupling of the electrical components to vehicle module 34. The bracket 18 may also be used in other industries outside of the automotive industry where mechanical/electrical systems include tight spaces.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A bracket for a module of a vehicle, the bracket comprising:
a body configured to be coupled to the vehicle; and
a pair of opposed guide rails extending from the body, each guide rail of the pair of opposed guide rails defining a channel configured to receive a respective mounting feature of the module, each guide rail of the pair of opposed guide rails further comprises a first cutout in communication with the channel at a first location of the guide rail and configured to receive the respective mounting feature from the channel.

2. The bracket of claim 1, further comprising a pair of rail surfaces configured to support the module, each rail surface of the pair of rail surfaces extending between the body and a respective guide rail of the pair of opposed guide rails.

3. The bracket of claim 2, wherein the first cutout includes a first portion in communication with the channel and a second portion in communication with the first portion, and wherein the second portion is located closer towards the rail surface then the first portion.

4. The bracket of claim 2, wherein the first cutout includes a first portion in communication with the channel and a second portion in communication with the first portion, and wherein the second portion is located closer towards an end of the guide rail then the first portion.

5. The bracket of claim 1, wherein each guide rail of the pair of opposed guide rails further includes a second cutout in communication with the channel at a second location of the guide rail and configured to receive the respective mounting feature from the channel, the second cutout is spaced apart from the first location.

6. The bracket of claim 5, wherein a shape of the first cutout is different from a shape of the second cutout.

7. The bracket of claim 1, wherein each guide rail of the pair of opposed guide rails includes a flat portion and an arcuate portion, and wherein the arcuate portion defines the channel.

8. The bracket of claim 7, wherein the first cutout is formed in the flat portion and the arcuate portion.

9. The bracket of claim 1, further comprising a plurality of mounting features configured to couple the bracket to the module, at least one mounting feature of the plurality of mounting features extending from an upper end of the body and at least one mounting feature of the plurality of mounting features extending from a lower end of the body.

10. The bracket of claim 9, further comprising a stop member extending from the upper end of the body above the pair of opposed guide rails.

11. The bracket of claim 1, further comprising a stop member extending from an upper end of the body above the pair of opposed guide rails.

12. A bracket for a module of a vehicle, the bracket comprising:
a body configured to be coupled to the vehicle; and
a pair of opposed guide rails extending from the body, each guide rail of the pair of opposed guide rails includes a first part, a second part, a first cutout and a second cutout, the second part having a different shape then the first part and defining a channel configured to receive a respective mounting feature of the module, the first cutout formed in the guide rail of the pair of opposed guide rails, the first cutout in communication with the channel at a first location of the guide rail and configured to receive the respective mounting feature from the channel, the second cutout formed in the guide rail of the pair of opposed guide rails, the second cutout in communication with the channel at a second location of the guide rail and configured to receive the respective mounting feature from the channel.

13. The bracket of claim 12, wherein the first part is flat, and the second part is arcuate.

14. The bracket of claim 13, wherein the first cutout is formed in flat first part and the arcuate second part of the guide rail, and wherein the second cutout is formed in the flat first part and the arcuate second part of the guide rail.

15. The bracket of claim 12, further comprising a pair of rail surfaces configured to support the module, each rail surface of the pair of rail surfaces extending between the body and a respective guide rail of the pair of opposed guide rails.

16. The bracket of claim 15, wherein each of the first cutout and the second cutout includes a first portion in communication with the channel and a second portion in communication with the first portion, and wherein the second portion is located closer towards the rail surface then the first portion.

17. A method comprising:
inserting a vehicle module into a bracket such that mounting features of the vehicle module are received in channels of a pair of opposed guide rails of the bracket;
moving the vehicle module into a first position in which the mounting features are moved from the channels to first cutouts in the pair of opposed guide rails; and
coupling a first set of electrical components to corresponding first terminals of the vehicle module while the vehicle module is in the first position.

18. The method of claim 17, further comprising:
moving the vehicle module from the first position after the first set of electrical components are coupled to the corresponding first terminals;
moving the vehicle module into a second position in which the mounting features are moved from the channels to second cutouts in the pair of opposed guide rails; and
coupling a second set of electrical components to corresponding second terminals of the vehicle module while the vehicle module is in the second position.

19. The method of claim 18, wherein the vehicle module moves in a substantially vertical direction from the first position to the second position.

20. The method of claim 18, further comprising securing the vehicle module and the bracket to each other after the first set of electrical components are coupled to the corresponding first terminals and the second set of electrical components are coupled to the corresponding second terminals.
